(19) United States
(12) Patent Application Publication
(10) Pub. No.: US 2013/0204517 A1
(43) Pub. Date: Aug. 8, 2013

(54) Method and Apparatus for Alerting a Driver of Warning Conditions

(71) Applicants: Madhuri Raju, Farmington Hills, MI (US); Joseph Carl Beiser, Northville, MI (US); Gerald Douglas Neely, Canton, MI (US)

(72) Inventors: Madhuri Raju, Farmington Hills, MI (US); Joseph Carl Beiser, Northville, MI (US); Gerald Douglas Neely, Canton, MI (US)

(73) Assignee: FORD GLOBAL TECHNOLOGIES, LLC, Dearborn, MI (US)

(21) Appl. No.: 13/368,598

(22) Filed: Feb. 8, 2012

(51) Int. Cl. G01C 21/00

(52) U.S. Cl. 701/400

(57) ABSTRACT

A computer implemented method includes receiving route data from an in-vehicle process. The method further includes setting one or more geo-fences corresponding to known conditions along a route defined by the route data. The method additionally includes sending the geo-fences to the in-vehicle process for monitoring.

### TECHNICAL FIELD

The illustrative embodiments generally relate to a method and apparatus for alerting a driver of warning conditions.

### BACKGROUND

The addition of vehicle information and infotainment systems to vehicles provides a wealth of entertainment and information delivery options for vehicle occupants. Through on-board resources and remote connections, occupants can stream music and movies, receive news updates, access remote databases, obtain navigation information and perform numerous other tasks that used to require a secondary computing system, such as a smart phone or PC with a wireless network card.

Using the onboard system, drivers can communicate with off board, cloud-based resources and access virtually any information useful for driving or travel. Certain software addons allow users to be smart-routed to recommended stopping points, obtain coupons or deals tailored to users, and even alert emergency providers and/or user doctor's in the event of a medical emergency.

In most of the systems, however, the process is a “pull” type process. A particular off-board resource responds to a user request for information, or user need. These needs are often conveyed from an on-board system to the remote system, and the remote system responds to the particulars of a request.

“Pull” systems are very useful for providing for the needs of a user when the user knows that a particular need exists. They cannot, however, always address the needs of a user who is unaware that a particular available solution or option could be beneficial in a particular situation.

### SUMMARY

In a first illustrative embodiment, a computer implemented method includes receiving route data from an in-vehicle process. The illustrative method further includes setting one or more geo-fences corresponding to known conditions along a route defined by the route data. The method additionally includes sending the geo-fences to the in-vehicle process for monitoring.

In a second illustrative example, a machine readable storage medium stores instructions which, when executed by a processor, cause the processor to perform the method including receiving route data from an in-vehicle process. The illustrative method further includes setting one or more geo-fences corresponding to known conditions along a route defined by the route data. The illustrative method also includes sending the geo-fences to the in-vehicle process for monitoring.

In a third illustrative embodiment, a computer-implemented method includes sending route data to a remote server for processing. The method further includes responsively receiving one or more geo-fences associated with conditions along a route defined by the route data. The method additionally includes monitoring the progress of a vehicle until a boundary of one of the geo-fences is reached. Also, the illustrative method includes notifying the remote server that the boundary was reached, including sending vehicle coordinate data.

In a fourth illustrative embodiment, a computer implemented method includes receiving route data at an off-board system transmitted from a vehicle. The method also includes comparing route data to known hazards to determine hazard conditions along a route. The non-limiting method further includes estimating a vehicle location along a route as the vehicle travels. Also, the method includes/transmitting hazard warnings when a vehicle estimated location is within a predefined proximity to a known hazardous condition.

### BRIEF DESCRIPTION OF THE DRAWINGS

FIG. 1 shows an illustrative vehicle computing system;

FIG. 2 shows an illustrative process for monitoring vehicle travel;

FIG. 3 shows an illustrative process for on-board tracking initiation;

FIG. 4 shows an illustrative process for remote system communication;

FIG. 5 shows an illustrative process for remotely sending updates to a vehicle;

FIG. 6 shows an illustrative process for updating parameters associated with a traveling vehicle; and

FIG. 7 shows another illustrative process for route hazard monitoring.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

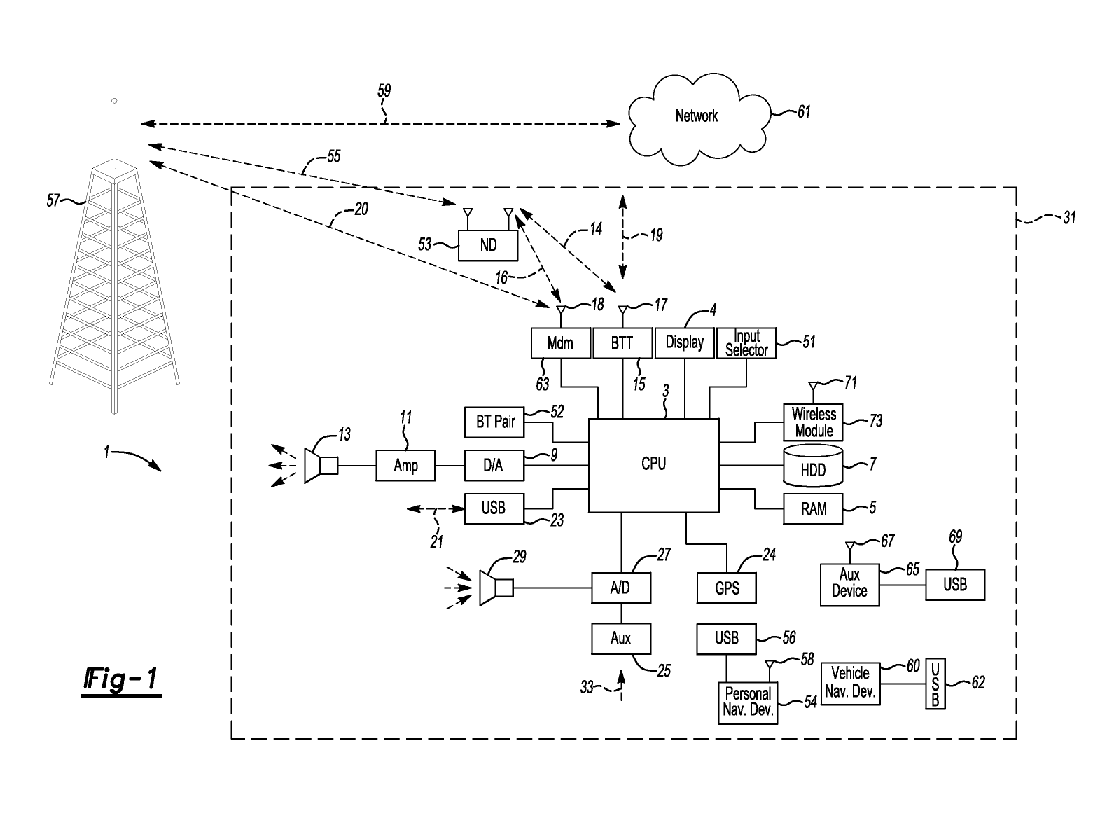

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In the illustrative embodiments, systems are contemplated that “push” data to a vehicle as it is needed by a driver. Instead of waiting for specific requests from a driver, and then responding to the requests, the illustrative embodiments determine what information may be needed or useful to a driver and then send that information to the vehicle dynamically. Working with, for example, a known vehicle route, the processes detailed herein determine potential areas of hazard or driver concern along those routes. These can include, but are not limited to, weather conditions, allergen conditions, hazardous material or emergency conditions, etc.

Although a driver, at the start of a route, could request information on these conditions, many drivers may not remember to do so. For example, if it is sunny when a driver leaves the house, the driver may not think about the possibility of hazardous weather along a route. Or, in another example, the driver could ask for a weather report and receive an all clear report. The driver may then lower the roof of a convertible, and set out for a drive. Assuming that the weather will be fine, the driver could continue driving along a route, when a storm system that suddenly developed could hit the driver. Utilizing the illustrative embodiments, drivers can be dynamically warned of inclement situations prior to encountering them, even if the information is not specifically requested.

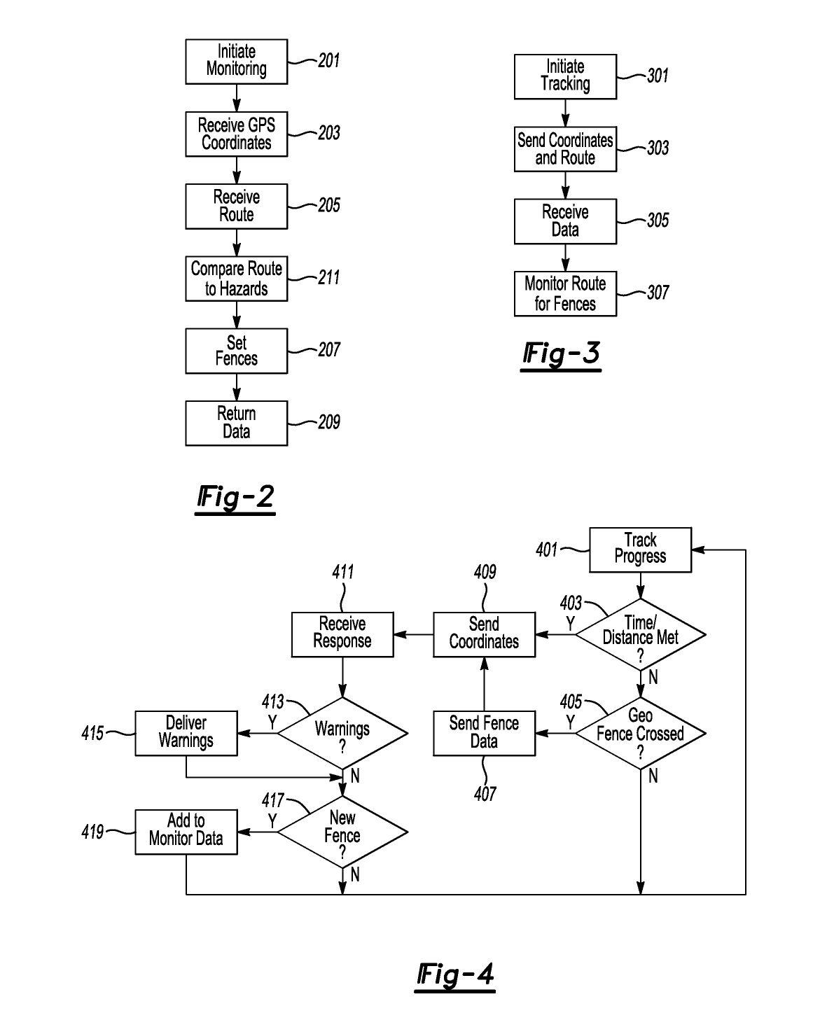

FIG. 2 shows an illustrative process for monitoring vehicle travel. In this example, a remote system interacts with an onboard system (in-vehicle system, application on a wireless device in the vehicle, etc.). The interaction allows the remote system to highlight potential problem areas along a route, and the vehicle can then notify the remote system automatically when the vehicle approaches a designated area. These areas can be called geofences, in one example, and be designated by coordinate boundaries, coordinate lines, road intersections or crossings, or any other suitable means of determining a geographic point at which an update may be required.

In this illustrative embodiment, the remote process begins monitoring when it receives a notification that a vehicle has begun a route 201. This initiation program can be run constantly and set up for each vehicle that interacts with it. Or separate instances can be run as needed, for individual vehicles, vehicles in a particular region, etc.

In addition to receiving notification from the vehicle, the process also receives the current GPS coordinates of the vehicle 203. This information can be used to allow the remote system to determine where the vehicle is currently located, where a route is beginning, and to provide any information dynamically about potential hazardous or undesirable conditions proximate to the vehicle's current position.

After receiving the vehicle coordinates, the process also receives a vehicle route (if available). In at least one instance, a route can be predictively determined using known techniques, or the route could be driver input. The route can then be compared to instances of hazardous and undesirable situations that are known to the remote system 211. This information can provide the system with points along the route where these conditions may exist.

Because it may be preferable to notify a driver of an inclement condition before the driver arrives at the actual point where the condition is occurring, the process may set a “fence” around the condition(s) 207. For example, if it is raining at location X, a fence of suitable distance around X may be set such that the driver will likely cross the fence prior to encountering actual rain. The fence can be fixed or it can be set to move according to some plan, such as, but not limited to, in the know direction of the movement of a weather system. Although weather systems are used in this example for illustrative purposes, the applications of the invention are not limited thereto.

In another example, the fence may be fixed in location at inception, but can be updated over time as a vehicle progresses along a route. For example, the system may be moving in an unpredictable manner, or dynamic, moving fencing may not be desired. In this instance, the process may periodically recheck conditions against the route and reset the fences in accordance with known positions of potential hazards.

Because occurrences that could be bothersome to certain individuals may not bother others, the system can also use stored driver/occupant information to determine which conditions to report. The driver may preset this information, or the information could be obtained from other input information sent through the vehicle system. For example, if a driver had allergies, it may be useful to notify that driver of inclement pollen conditions along a route. On the other hand, a driver who is allergy free may not need or even want these notifications. Utilizing information specific to a driver/occupant can allow more precise delivery of desirable, useful information.

Once the appropriate fences have been determined and set, the information can be returned to the vehicle 209. In one illustrative embodiment the vehicle tracks when it has crossed a set fence. In another illustrative embodiment, the offboard system will periodically receive information from a vehicle, including that vehicle's location, and can determine if a fence, stored off-board, has been crossed. In the off-board model, the system can more easily update fences as information changes, but in the on-board model the vehicle can notify the remote system as soon as a fence has been crossed. It is also possible to utilize both models for monitoring if desired.

FIG. 3 shows an illustrative process for on-board tracking initiation. In this illustrative embodiment, the process is an on-board process or is running on a mobile device in the vehicle. The data from the remote server is “pushed” to the process as needed, once the process has been initiated and tracking has begun.

In this illustrative example, the process initiates a tracking step 301, which will potentially involve a call to the remote server to initiate a monitoring step on the server-side. Once the server side process has been initiated, if needed, the process then sends current vehicle coordinates and/or a route if available 303. In at least one embodiment, not shown, if a route is unknown the process may ask the user to input a route or attempt to predict a route based on known techniques.

After the sent data is received server-side, it is processed by a server side process and returns any warning data and/or fencing data. This data is received by the vehicle-side process 305. Any fence data is then stored vehicle-side and as the vehicle travels the process periodically or continually determines if any geo-fences have been crossed 307.

FIG. 4 shows an illustrative process for remote system communication. In this illustrative process, a vehicle-side monitoring process has been engaged. As previously mentioned, the fence monitoring can also occur on the server side, and the vehicle can merely relay coordinates to the server for tracking purposes.

In this non-limiting example, the vehicle-side process tracks the position of the vehicle 401. This can be done, for example, using GPS coordinates or other suitable tracking methods that can provide locations that can be compared against the fence coordinates. In addition to tracking the vehicle to determine fence intersections, the process also tracks general vehicle position, in order to periodically check to ensure that a new, previously unknown warning situation has not arisen.

In this example, if a predetermined time/distance/etc. has elapsed 403, the system will send the current coordinates of the vehicle to a remote system for processing. In this example, since any potential warning will be received if the coordinates are proximate to a warning state, the fence check will not be made in the case where coordinates are sent as a part of the periodic transmission. If there is no periodic transmission due, however, the process then checks to see if a geo-fence has been crossed 405.

If the fence has not been crossed, and there are no periodic transmissions to be sent, the process loops and continues to monitor for coordinate changes or fence crossings. If a fence has been crossed, however, the process sends data relating to the fence that was crossed 407, in addition to the coordinate data 409.

While it is also possible simply to send coordinate data when a fence is crossed, in this example sending data (such as a fence name or affiliated fence attributes) allows the remote process to cross reference the sent fence data with, for example, without limitation, an event or condition affiliated with that fence. If the event or condition has changed, a dynamic update of the fence can be pushed to the vehicle, as well as any needed warnings. This can help the fence adaptively change as new data becomes available, while at the same time providing tracking of conditions associated with the fence.

Any responses sent from the remote server, such as, but not limited to, warnings, new fences, fence updates, etc. are received by the in-vehicle system 411. If there are any new warnings to be delivered 413, the process delivers the warnings to the occupants 415. If there is new or updated fence data pushed responsively from the server 417, the process can add the fence data to the monitoring process 419, so that checks against the new or updated boundaries can occur.

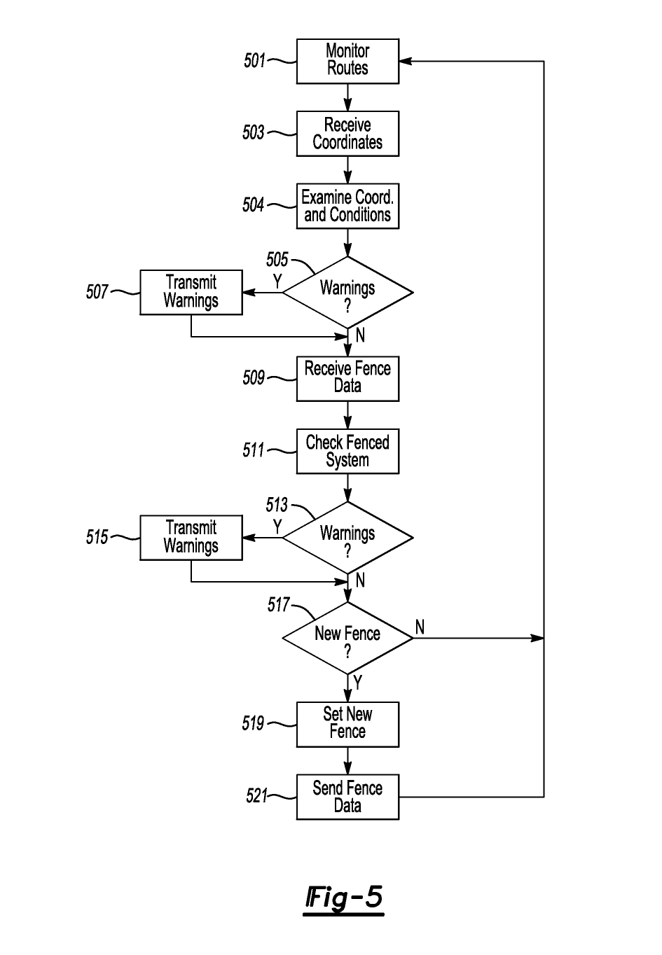

FIG. 5 shows an illustrative process for remotely sending updates to a vehicle. In this illustrative example, the remote server is receiving coordinate data from the vehicle as well as data relating to fence crossings. In other examples, the remote server may simply receive coordinate data or other appropriate tracking data, and use fence information stored on the server to track warning conditions.

In this non-limiting embodiment, the remote process is monitoring one or more routes as desired 501. Coordinate or similar data is received from an in-vehicle process in accordance with a send of that data from the in-vehicle process 503. The coordinate data is then examined to see if a warning condition corresponds to the sent coordinate data 504.

If there is a warning that needs to be delivered 505, the process will transmit the warning to the in-vehicle process for delivery to the vehicle occupants 507. If there is no warning to be transmitted, or once the warning has been transmitted, in this embodiment, the process may also then receive fence-crossing data 509, indicating that a predetermined geo-fence has been reached or crossed by the vehicle.

The received fence data can be checked against the system, condition, etc. associated with that particular fence or fences 511. If the condition has changed, ceased to exist, moved, etc., it may not be necessary to deliver a warning, but if a warning is needed 513 a warning associated with the particular condition can be delivered to the in-vehicle system 515.

In addition to delivering a warning, the process may determine that a new fence or an alteration of the existing fence is needed 517. This new fence could correspond to a new fence affiliated with any point on the route, a new fence affiliated with received coordinate data, deletion of an existing fence, alteration of an existing fence (either for which data was received or elsewhere along a route), or any other suitable fence alteration/creation. In at least one embodiment, the fence data “received” could simply be NULL data, but the process could continue on to see if creation of new fences or alteration of existing fences is needed.

If one or more new fences need to be created, or if any existing fences need to be altered, the process will designate new boundaries for the fences 519. This boundary data can then be delivered to the in-vehicle process 521. At this point, the system can resume monitoring the progress of the vehicle and receive additional updates in the future as needed.

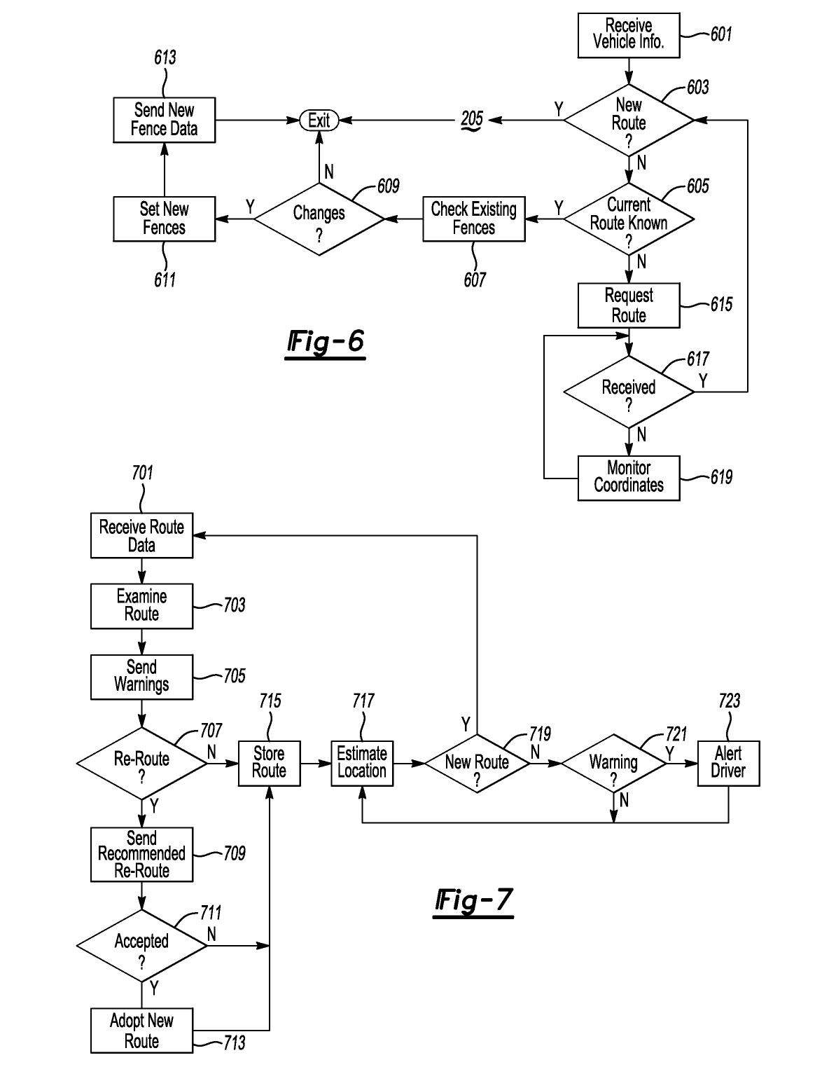

FIG. 6 shows an illustrative process for updating parameters associated with a traveling vehicle. In this example, the remote system is shown with additional functionality for creation and alteration of fences. As with all processes in this application, this process is exemplary and is intended to show possible steps that may be taken by a remote system. It is not intended to limit the scope of the invention thereto.

In this example, vehicle information is received 601. If, for example, the remote server stores a record of current fence data for traveling vehicles, the vehicle information could be used to look up existing stored data. Additionally or alternatively, route data could be included in the vehicle information package, so that the remote server can set monitoring data for a new route and/or compare the received route to a stored known route for a particular vehicle.

In at least one instance, it may be desirable to at least temporarily store route data for each vehicle. In addition to providing metric and tracking data for vehicle travel tracking, vehicle usage tracking, predictive routing routines, etc., the stored data can be edited even if an in-vehicle process is not currently sending information, so that fencing can be kept up-to-date in real-time or near real-time. In this manner, even if the system is heavily engaged when coordinate data for a particular vehicle is received, a simple lookup of previously updated and stored data may provide the information to be pushed to a particular vehicle. This could allow the remote server(s) to update numerous vehicle routes with new data while cycles are low and server loads are light. Additionally or alternatively, if the data is stored remotely, whenever a geo-fence is altered the process could push the altered geo-fence data to a given vehicle.

In this illustrative example, the process checks a received route against an existing route (which may be a NULL route) to see if a new route has been received 603. If a new route has been received, the process can go to step 205, for example, of FIG. 2 and process the new route data for a new tracking/fence system.

If the route data corresponds to an already known route, and is not a new route, or if the route data received is NULL (e.g., no route entered), the process can make a determination between the two 605. If a route is NULL or unknown, the process can request a route from an in-vehicle process 615. The request sent to the in-vehicle process can be conveyed to a driver and/or can cause engagement of a predictive algorithm to “guess” at a route based on known techniques.

If a responsive new route is received 617, after sending the request for the route , the system can again go to, for example, without limitation, a process such as step 205 of FIG. 2 to handle the new route. If the new route has not yet been received, the remote process can still handle any received coordinates 619 so that a driver can be notified of any local conditions that exist or are upcoming when coordinates are received.

If a received route corresponds to a previously known route 605, the process can then check existing fences along that route to see if changes to those fences need to be pushed to the in-vehicle process 607. As previously noted, the fences associated with a given route may be remotely stored in a repository and associated with a particular vehicle. If there have been changes to the fences, or new fences have been/need to be added, any unsaved changes can be stored in the repository 611, and the new/altered data can be pushed to the vehicle.

FIG. 7 shows another illustrative process for route hazard monitoring. In this illustrative example, communication between the vehicle and the remote system is kept to a minimum. At the onset of the process, the remote system receives route data transferred from, for example, the vehicle 701. The data is compared to existing known conditions 703, and any relevant warnings are sent to a vehicle user 705.

In some instances, a hazard may be desirable to avoid altogether, so the process may recommend one or more re-routes 707. Avoided hazards can include, but are not limited to, severe weather, high allergen count areas for drivers with allergies, etc. If there are any recommended re-routes, the remote process can determine avoidance routes and send the route(s) to the vehicle 709. If the driver responds by accepting the new routes 711, the new route can be adopted as the “current” route 713.

The process will then, at least temporarily, store the route in an associated storage area 715. This route, in conjunction with speed data, traffic data, weather data, driver behavior data, etc., can be used to estimate a vehicle position at any point in time 717. While the vehicle is traveling, if a new route is entered or the vehicle goes substantially off-route, the process may receive a “new route” indication 719. This can cause the whole process to loop, treating the new route as the current route and performing the appropriate steps.

If there is not a new route, the system checks an estimated vehicle position against hazard conditions to see if a warning (or re-route) is needed 721. If a warning or re-route is needed, the process alerts the driver 723 and then resumes travel monitoring. Additionally, although not shown, when communication is opened with the vehicle for purposes of warning transmission, vehicle position can also be updated using bi-directional communication, so that the estimated position can be kept as close to the actual position as possible.

Utilizing the illustrative embodiments, a driver/occupant can dynamically receive hazardous condition data (or any other data) without having to explicitly request the particular data. In this manner, the illustrative embodiments can serve to “anticipate” the driver's needs and provide a better driving experience.

Utilizing hazard data and route information, embodiments can forecast fences and incidents along a route. That is, when a route is initiated, the process may already know about potential areas of problem along the route, some distance/time away. This information can be used in providing re-routing, and/or in alerting a driver long before an area of concern is reached.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-14. (canceled)

15. A computer-implemented method comprising:
sending route data to a remote server for processing;
responsively receiving one or more geo-fences associated with hazardous conditions along a route defined by the route data;
monitoring the progress of a vehicle until a boundary of one of the geo-fences is reached; and
notifying the remote server that the boundary was reached, including sending vehicle coordinate data.

16. The method of claim 15, wherein the notifying includes sending data identifying the geo-fence whose boundary was reached.

17. The method of claim 15, further comprising:
responsive to the notifying, receiving a warning associated with a hazardous condition for which a geo-fence was set; and
notifying a vehicle occupant of the warning.

18. The method of claim 15, further comprising:
periodically sending vehicle coordinate data to the remote server;
responsive to the sending, receiving a warning associated with a hazardous condition existing within a predefined distance of vehicle coordinates; and
notifying a vehicle occupant of the warning.

19. The method of claim 18, further comprising:
locally storing the geo-fences.

20. The method of claim 19, further comprising:
receiving updated geo-fence data corresponding to a change in at least one stored geo-fence based on a change in the hazardous condition to which the geo-fence corresponds; and
replacing the at least one stored geo-fence with a new geo-fence defined by the updated geo-fence data.

21-23. (canceled)
